(19) United States
(12) Patent Application Publication
(10) Pub. No.: US 2020/0040935 A1
(43) Pub. Date: Feb. 6, 2020

(54) LOW AXIAL FORCE SEALING SYSTEM

(71) Applicant: Acument Intellectual Properties, LLC, Sterling Heights, MI (US)

(72) Inventors: Max Juengel, Grand Blanc, MI (US); Jeramiah Slater, Grand Blanc, MI (US)

(21) Appl. No.: 16/460,559

(22) Filed: Jul. 2, 2019

Related U.S. Application Data
(60) Provisional application No. 62/713,648, filed on Aug. 2, 2018.

(51) Int. Cl. F16B 43/00; F16B 35/04

(52) U.S. Cl. CPC F16B 43/001; F16B 35/041

(57) ABSTRACT

A deformable fastening system that has a deformable member and a mating member that seal together at a reduced clamp load from a conventional fastening system. The deformable member reduces the axial force that is required to install a fastener. The system can be used in connection with the installation of various fasteners with one or more steps under the head of the bolt, or a deformable washer with at least one step or at least one taper. The stepped configuration provides a reduced contact area where the stepped portion contacts the mating member which translates into reduced clamp force range for a given torque. Thus, less axial force is needed to properly install the fastener. Alternatively, a non-deformable bolt with a clinch feature and a stepped underhead forms a seal with deformed staking material when the bolt is staked in the staking material.

### BACKGROUND

The present invention generally relates to systems for reducing the clamp force required to effectively install bolts, such as flow bolts.

When two or more materials are assembled together using one or more fasteners, the fasteners that clamp the materials together provide a clamp load or clamp force. While the clamp force needs to be significant enough to adequately secure the materials together, the clamp force should not be so great as to compromise the materials being secured.

In an attempt to apply just the right amount of clamp force, torque wrenches are often used to tighten the fasteners. Torque wrenches include a dial that provides a visual indication regarding the amount of torque being applied. Other clamp load indicating devices, such as encapsulated liquids, are sometimes used in the industry to prevent the application of too much clamp force.

Some applications require flow bolts. Flow bolts are bolts which are specifically configured to provide a seal at one or more points, yet allow fluid flow either along a through hole formed through the shaft of the bolt or along a fluid flow path provided along the shaft of the bolt. For example, some flow bolts have one or more external flutes cut or otherwise formed across the threads. As a result of the flow bolt having one or more external flutes formed across the threads, the flow bolt can generally handle less clamp force before the threads of either the bolt or a nut member become stripped. More specifically, the threads on the flow bolt and/or a nut member are susceptible to becoming stripped while the fastener is being tightened in an attempt to achieve sufficient axial force to obtain a proper seal. Even standard flow bolts which do not have one or more external flutes cut or otherwise formed across the threads require a reduced clamp load due to the lower cross-sectional area of the bolt.

As shown in FIGS. 1A, and 1B, one typical application in which a flow bolt 10 is used is in connection with a brake hose 12 for a motor vehicle. More specifically, the flow bolt 10 is inserted through a bore 14 in a connector 16 at the end of the brake hose 12 such that one metal washer 20 is positioned between the head 22 of the flow bolt 10 and the connector 16 at the end of the brake hose 12, and another metal washer 24 is positioned between the connector 16 and a securing member 26, such as a nut member, on the flow bolt 10. Then, the flow bolt 10 is tightened, causing both washers 20, 24 to compress thereby forming a seal between the connector 16 and each of the washers 20, 24, as shown in FIGS. 2A and 2B. Because the washers 20, 24 must compress during installation of the flow bolt 10, copper is typically chosen as the material for the washers. Also, because the washers effectively compress or crush during installation, the washers used in such an application are often called “crush washers.”

In order to form proper seals between the copper washers 20, 24 and the connector 16 at the end of the brake hose 12, sufficient axial force must be applied to the flow bolt 10. In other words, the flow bolt 10 and nut member 26 must be tightened sufficiently such that the copper washers 20, 24 become pressed into the connector 16 hard enough to form a seal. However, threads on the flow bolt 10 and/or the nut member 26 can become stripped while achieving an axial force that is sufficient to form this seal, especially if the bolt includes one or more external flutes 28 across the threads.

### SUMMARY

An object of an embodiment of the present invention is to provide a deformable fastening system that requires a reduced clamp load to seal the deformable fastening system than is required to seal a conventional fastening system.

An object of an embodiment of the present invention is to provide a system that reduces the axial force that is required to properly install a fastening member.

Another object of an embodiment of the present invention is to provide a system that reduces the axial force that is required to obtain a desired clamp load when a fastener, such as a washer and bolt combination, a bolt or a flow bolt is installed.

Another object of an embodiment of the invention is to provide a reduction in clamp force range for a given torque, thereby requiring less axial force needed to properly install the fastener.

Yet another object of an embodiment of the present invention is to provide a system that reduces the clamp load required to obtain a seal when a flow bolt is installed, where the reduction in the clamp load is equal to or greater than the reduction in clamp load that can be accommodated due to either one or more external flutes being provided across the threads of the bolt or simply because the bolt is a flow bolt and is provided as having a reduced cross-section.

Still yet another object of an embodiment of the present invention is to provide a system that reduces the crush area of a deformable member.

Still yet another object of an embodiment of the present invention is to provide a system that provides a deformable fastening system that includes a sealing clinch feature.

In an embodiment of the present invention, a deformable fastening system comprises a deformable member; and a mating member that seals with the deformable member, wherein the deformable member requires a reduced clamp load to seal with the mating member than a clamp load required to seal a non-deformable member with a conventional mating member in a conventional fastening system.

In an embodiment of the present invention, the deformable member comprises: a fastener including at least one step having an inner portion having a first side and a second side opposing the first side, wherein the inner portion is bounded by an inner maximum dimension and at least one first outer portion integrally formed with and protruding outwardly from the inner portion first side defining a first outer surface bounded by a first outer maximum dimension less than the inner maximum dimension

In an embodiment of the present invention, the first axial force applied to the fastening member to reach the a required axial force is less than a second axial force applied to a conventional fastener to seal the conventional fastening system.

In another embodiment of the present invention, the at least one outer portion has either a rectangular side profile or a first tapered portion defining a first tapered profile and a first planar portion defining the first outer portion.

In an embodiment of the present invention, the deformable member is a washer having a uniform middle portion defining the inner portion.

In an embodiment of the present invention, the washer either has at least one rectangular step or a taper on each side of the inner portion of the washer. The at least one rectangular step or taper on the washer reduces the effective contact surface area when compared to a conventional shape. A conventional washer is circular, has a hole in the middle, and is flat on both the top and the bottom. Unlike a conventional washer, a washer in accordance with an embodiment of the present invention provides either a stepped or tapered configuration, wherein both the top and the bottom of the washer are either stepped or tapered, thereby providing for a reduced contact surface area which effectively translates into less axial force being needed to properly install the fastener.

In an embodiment of the present invention, the washer has at least one second outer portion integrally formed with the uniform middle portion that protrudes outwardly from the uniform middle portion second side defining a second outer surface bounded by a second outer maximum dimension less than the inner maximum dimension.

In an embodiment of the present invention, the washer at least one outer portion comprises a first rectangular side profile.

In an embodiment of the present invention, the washer at least one second outer portion comprises: a second rectangular side profile.

In an embodiment of the present invention, the washer at least one first outer portion comprises a first tapered portion defining a first tapered profile and a first planar portion defining the first outer surface.

In an embodiment of the present invention, the washer at least one second outer portion comprises: a second tapered portion defining a second tapered profile and a second planar portion defining the second outer surface.

In an embodiment of the present invention, the mating member comprises: a non-deformable fastener having at least one outer portion, wherein the non-deformable fastener at least one outer portion contacts the deformable member to deform the deformable member.

In an embodiment of the present invention, the non-deformable fastener is a bolt having a shank and head, the head including an underside including at least one step defining the outer portion, wherein the at least one step mates with the deformable member to deform the deformable member and continues to deform the deformable member until the outer portion contacts the deformable member at a desired clamp load.

In an embodiment of the invention, the deformable member receives the bolt and may comprise either a washer or a clamped component.

In another embodiment of the present invention, the non-deformable fastener comprises a clinch fastener that seals with the deformable member, wherein the deformable member is a staking material.

In an embodiment of the present invention, the clinch fastener comprises: a bolt having a shank and a head, the head including an undersurface including at least one step defining the at least one outer portion, wherein the at least one step mates with the staking material to deform. clinch, and seal with the staking material.

In an embodiment of the invention, the clinch fastener comprises retention groove, wherein when the bolt is staked through the staking material, a portion of the deformable staking material flows into the retention groove.

In an embodiment of the invention, the at least one step is not deformable and mates with the deformable member. In another embodiment of the invention, the at least one step is deformable and forms a seal with the mating member.

In another embodiment of the present invention, the bolt can be used in a system which also comprises a nut member and a clamped component between the bolt and the nut member, where preferably, the clamped component is formed of a material that is softer than both the bolt and the nut member and that deforms to seal with the bolt and nut member when the system is clamped together.

An embodiment of the present invention generally relates to fluid handling circuits that require tube or hose end fittings where clamp force is applied to form a leak-proof joint. Clamp force is generated by applying torque to a mechanical fastener that brings two or more parts together, forming an intimate contact. One or more of the parts in the joint will be softer than the others, usually a washer or clamped component, to deform under the clamp load to promote a leak-proof seal. Nevertheless, leaks can occur even with a normally applied torque if there is not enough material deformation to seal the fluid path. This is because adjacent soft and hard surfaces are flat and smooth, which forces the seal to rely primarily on the stiffness difference of the soft and hard material. An embodiment of the present invention integrates geometric features that promote the deformation of the softer material thus creating a more effective seal.

The present invention also includes an embodiment that relates to indicating and thus, helping to control the clamp force in a bolted joint. Torque is normally used to achieve the desired clamp load, but there is typically a large variation in actual clamp load due to the variation in frictional forces. An embodiment of the present invention integrates geometric features into a fastener to produce a visual clamp load indicator which functions to identify when the desired clamp load is achieved.

The present invention also includes an embodiment that relates to providing a seal in a clinched fastener system.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIGS. 1A, 1B, 2A and 2B show a prior art fastening system having a deformable fastening member being installed at the end of a brake hose. FIG. 1A shows an assembly view of the pre-installed state (in partial cross-section) and wherein, FIG. 1B shows an enlarged cross-sectional view of FIG. 1A, taken along the line A-A in FIG. 1A. FIG. 2A shows an assembly view of the post-installed state (in partial cross-section) and wherein, FIG. 2B shows an enlarged cross-sectional view of FIG. 2A, taken along the line B-B in FIG. 2A.

FIG. 3 provides a top view of a deformable washer that is in accordance with a first embodiment of the present invention, wherein the deformable washer has outer portions on both the top and the bottom where the outer portions each have a rectangular side profile;

FIG. 4 provides a side view of the deformable washer shown in FIG. 3.

FIGS. 5A, 5, B, 6A, and 6B show a deformable fastening system which is in accordance with an embodiment of the present invention being installed at the end of a brake hose, wherein the fastening system includes deformable members that are stepped washers, such as is shown in FIGS. 3 and 4. FIG. 5A shows an assembly view of the pre-installed state (in partial cross-section) and wherein, FIG. 5B shows an enlarged cross-sectional view of FIG. 5A, taken along the line C-C in FIG. 5A. FIG. 6A shows an assembly view of the post-installed state (in partial cross-section) and wherein, FIG. 6B shows an enlarged cross-sectional view of FIG. 6B, taken along the line D-D in FIG. 6A.

FIG. 7 provides a top view of a deformable washer that is in accordance with a second embodiment of the present invention, wherein the deformable washer is tapered on both the top and the bottom;

FIG. 8 provides a side view of the deformable washer shown in FIG. 7;

FIGS. 9A, 9B, 10A and 10B show a deformable fastening system which is in accordance with another embodiment of the present invention being installed at the end of a brake hose, wherein the deformable fastening system includes deformable members that are tapered washers, such as is shown in FIGS. 7 and 8.

FIG. 9A shows an assembly view of the pre-installed state (in partial cross-section) and wherein, FIG. 9B shows an enlarged cross-sectional view of FIG. 9A, taken along the line E-E in FIG. 9A.

FIG. 10A shows an assembly view of the post-installed state (in partial cross-section) and wherein, FIG. 10B shows an enlarged cross-sectional view of FIG. 10B, taken along the line F-F in FIG. 10A.

FIG. 11 provides a top view of a non-deformable fastener defined by a bolt which is in accordance with another embodiment of the present invention.

FIG. 12 provides a side, cross-sectional view of the bolt shown in FIG. 11, taken along line G-G of FIG. 11.

FIG. 13 provides a bottom view of the bolt shown in FIGS. 11 and 12; and

FIGS. 14 and 15 show a fastening system (in side, cross-section) which is in accordance with another embodiment of the present invention, wherein the fastening system includes a deformable fastening member defined by a bolt, such as is shown in FIGS. 11-13, and wherein FIG. 14 shows the pre-installed state while FIG. 15 shows the post-installed state of the system.

FIGS. 16, 17 and 18 show a deformable fastening system (in side, cross-section, and bottom view) which is in accordance with another embodiment of the present invention, wherein the fastening system includes a non-deformable fastener defined by a bolt, and wherein FIG. 16 shows the pre-installed state of the system, FIG. 17 shows a cross sectional view of Section H-H of FIG. 16, and FIG. 18 shows a bottom view of FIG. 16.

FIG. 19 shows the post-installed state of the bolt showed in FIGS. 16-19 installed to form a sealed deformable fastening system with a deformable member.

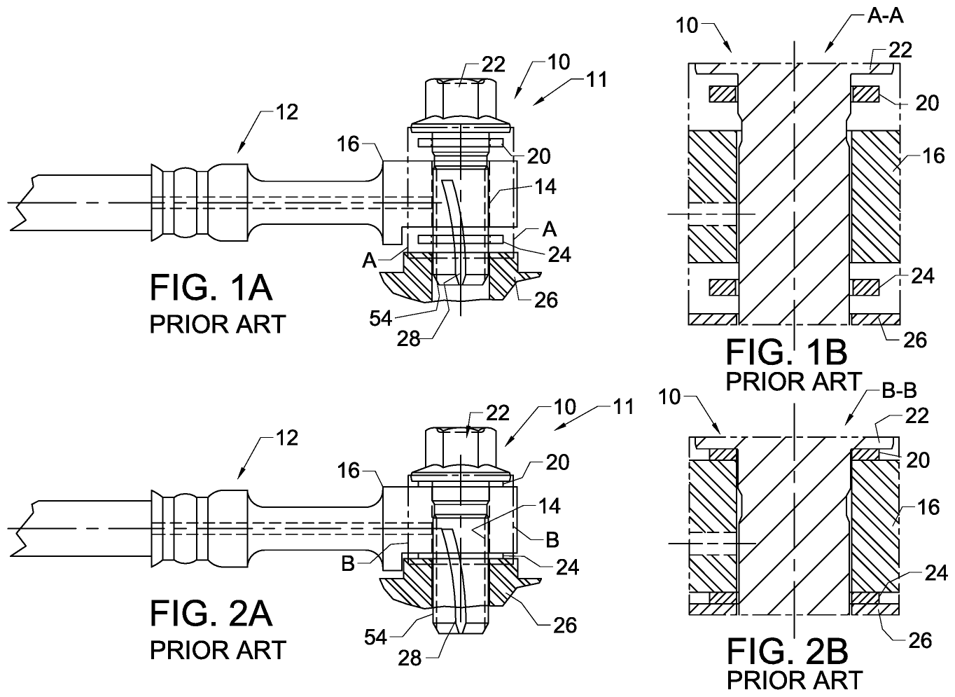

### DESCRIPTION OF ILLUSTRATED EMBODIMENTS

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

A plurality of embodiments of the present invention is disclosed herein. Each embodiment provides a system that reduces a resulting clamp force that is required to seal a deformable fastening system.

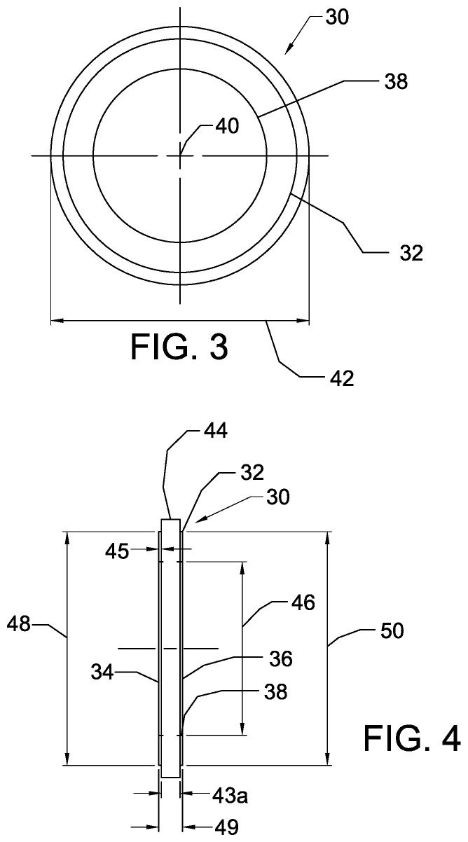

The deformable fastening system includes a deformable member and a mating member that seals with the deformable member. FIG. 3 provides a top view of the deformable member defined by a stepped washer 30 that is in accordance with an embodiment of the present invention, while FIG. 4 provides a side view of the same washer 30. As shown in FIGS. 3 and 4, the washer 30 includes at least one outer portion 32, shown as two outer portions 32 on both the top 34 and the bottom 36 of the washer 30 (while FIGS. 3 and 4 show one step 32 on both the top 34 and the bottom 36 of the washer, only one outer portion on only one side of the washer 30 may be provided. Additionally, the washer 30 can be provided as having more than one outer portions on each of the top 34 and bottom 36, or even an unequal number of outer portions on each of the top 34 and the bottom 36), and a hole 38 is provided in the center 40 of the washer. As such, the washer 30 has a uniform middle portion having an outer diameter 42 (FIG. 3) defined by the largest measurement, an inner maximum dimension, across the middle portion 44 of the washer 30 and an inner minimum diameter 46 defined by the hole 38 in the middle of the washer 30.

In an embodiment of the present invention, the washer has sides, a first and a second side, (top 34 and bottoms 38 shown in FIG. 4) wherein the first and second sides are bounded by a respective, first and second outer axial maximum dimensions, shown as outer diameters 48, 50 defined by at least one first and second outer portions (steps 32) of the washer 30.

Preferably, the washer 30 is symmetrical such that the outer diameter 48, 50 of each of the steps 32 (i.e., respectively on both the top 34 and the bottom 36 of the washer 30) is generally equal.

The outer portions 32 on the top 34 and bottom 36, respectively, of the washer 30 are preferably formed using two opposing dies that have the step(s) shape formed in them. A fixed stroke machine is preferably used to compress the washer material and form the steps using the dies. The steps can be formed either during normal production of the washer using specially shaped tooling (with the stepped features), or as a secondary operation using similar tooling.

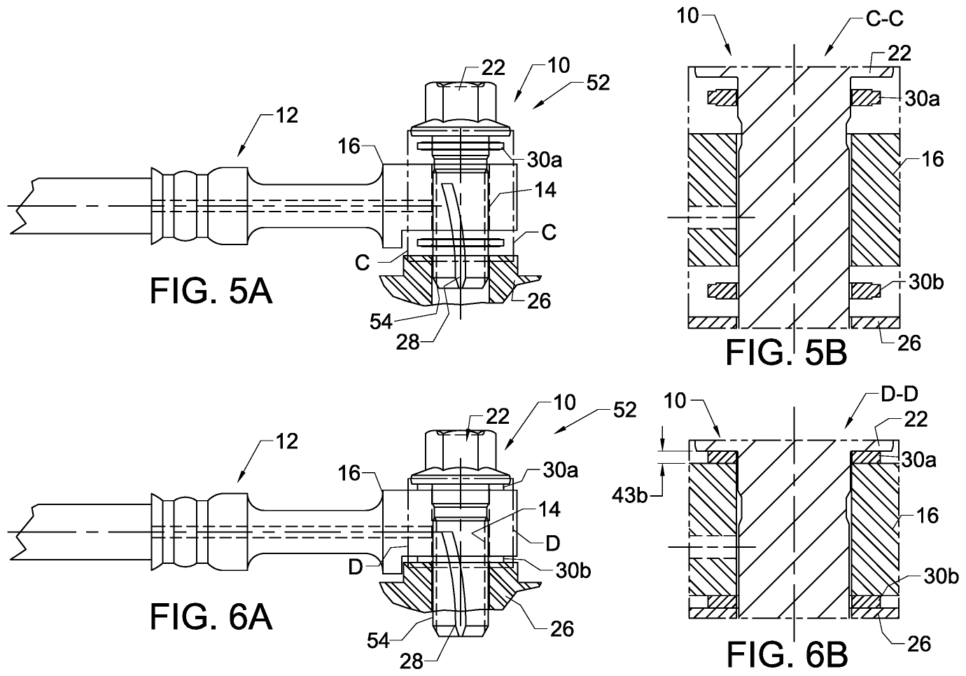

FIGS. 5A, 5B, 6A, and 6B show a deformable fastening system 52 being used to install a flow bolt 10 on a brake hose 12 where the deformable fastening system 52 employs the stepped deformable washer 30 shown in FIGS. 3 and 4, described previously. Specifically, FIGS. 5A and 5B show the pre-installed state while FIGS. 6A and 6B show the post-installed state. In fact, two of the stepped washers 30 are used. Therefore, in FIGS. 5A, 5B, 6A and 6B, one washer is identified with reference numeral 30a and the other is identified with reference numeral 30b, to distinguish one from the other, yet both are preferably identical to washer 30 shown in FIGS. 3 and 4.

Initially, a deformable stepped washer 30a (identical to the stepped washer 30 shown in FIGS. 3 and 4) is slid onto the shaft 54 of the flow bolt 10 and then the shaft 54 of the flow bolt 10 is inserted through a bore 14 provided in a connector 16 at the end of the brake hose 12. At this point, the washer 30a is disposed between a head 22 of the flow bolt 10 and the connector 16. Then, another stepped washer 30b (also preferably identical to the stepped washer 30 shown in FIGS. 3 and 4) is slid onto the shaft 54 of the flow bolt 10 and then a securing member 26, such as a nut member, is threaded or otherwise engaged with the shaft 54 of the flow bolt 10. At this point, the washer 30b is disposed between the connector 16 and the securing member 26, and the overall assembly looks as shown in FIG. 5. Then, the deformable fastener system 52 is tightened such as by rotating the head 22 of the flow bolt 10 and/or securing member 26, or the securing member 26 is crimped onto the shaft 54 of the flow bolt 10. Regardless, tightening of the fastening system 52 causes the stepped washers 30a, 30b to compress or crush against the connector 16 thereby forming a seal. During installation, the top 34 and bottom 36 of each of the washers 30a, 30b (see FIG. 6) can be crushed such that the thickness of each washer after installation equals the thickness of the middle portion 44 (shown in FIG. 4 for illustrative purposes) of the each washer as it existed before installation (see FIGS. 5A, and 5B), but this is not imperative.

Providing that the washers 30a, 30b have at least outer portion 32 (see washer 30 shown in FIGS. 3 and 4, which is identical) on both the top 34 and the bottom 36, and was effectively pre-crushed before being used in the flow bolt installation process provides that the clamp force is reduced as a result of the contact area of the sealed joint being reduced compared to the contact area of a conventional, non-stepped washer. Processing the washer 30 shown in FIGS. 3 and 4 to give it one or more outer portions on both the top 34 and the bottom 36 reduces the force required to install, for example, a flow bolt, while still maintaining the radial strength of the washer. Additionally, the washer 30 has a first thickness 49 before installation into the deformable fastening system that equals the sum of a middle portion thickness 43a measured longitudinally across the inform middle portion and a step thickness 45 measured longitudinally across the at least one step (or across each step where there are a plurality of steps), wherein, when installed into the deformable fastening system, the washer has a second thickness 43b (shown in FIG. 6B) equal to the middle portion thickness 43a due to the deformation of the washer.

In contrast, conventional washers are of a single thickness and have more crush area than necessary to seal and to ensure sufficient radial strength. Preferably, the washer design is matched to compensate for reduced thread strength in that the crush area is reduced approximately by the amount of thread strength reduction. The thread strength may be compromised in that the thread on either the flow bolt 10 or the nut member 26 may be susceptible to stripping if the flow bolt includes one or more external flutes 28 across the threads in order to provide a fluid flow path, such as is shown in FIGS. 5 and 6. Using stepped washers 30a, 30b (see FIGS. 3 and 4 which shows washer 30 which is identical) compared to conventional washers provides that less axial force is required to crush and seal the washers to the flow bolt 10 and to both the connector assembly 16 and securing member 26 due to the smaller washer contact area.

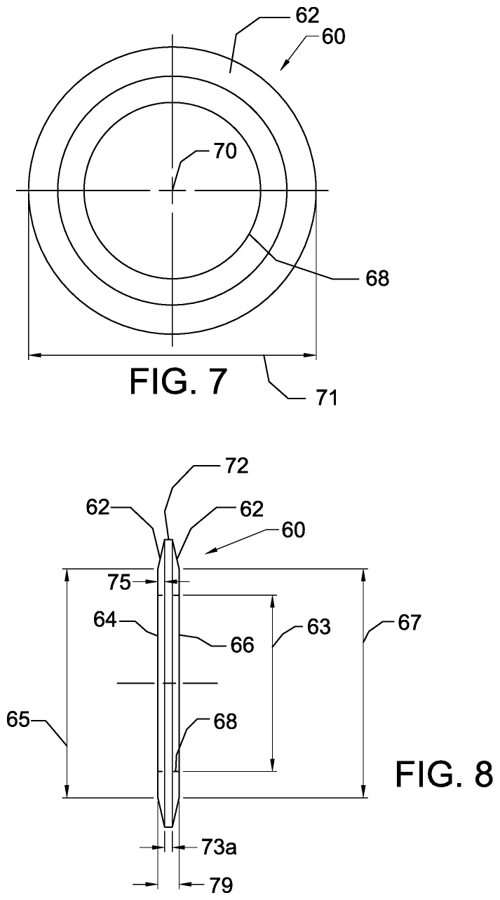

FIG. 7 provides a top view of a deformable member defined by a tapered washer 60 that is in accordance with another embodiment of the present invention, while FIG. 8 provides a side view of the same washer 60. As shown, the washer 60 includes at least one outer portion having at least one taper 62 and at least one uniform middle portion 72 having an inner maximum dimension 71. In an embodiment of the present invention shown in FIG. 8, there are two tapers 62 that are each respectively defined by a first and second tapered profile. There are also two planar portions shown in FIG. 8, a first planar portion, the top 64, having a and second planar portion, the bottom 66, respectively, defining a first and a second outer surface of the washer, and a hole 68 is provided in the center 70 of the washer having an inner minimum diameter 63.

The top 64 first planer surface and bottom 66 second planer surface, each respectively define a first outer maximum dimension 65, and a second outer maximum dimension 67 that is smaller than the first inner maximum dimension 71 of the uniform middle portion 72 of the washer 60. Preferably, the washer 60 is symmetrical such that each of the tapers 62 (i.e., on both the top 64 and the bottom 66 of the washer) are generally the same with regard to height and slope.

Additionally, the washer 60 (shown in FIG. 8 has a first thickness 79 before installation into the deformable fastening system that equals the sum of a middle portion thickness 73a measured longitudinally across the inform middle portion and a step thickness 75 measured longitudinally across the at least one step (or across each step where there are a plurality of steps), wherein, when installed into the deformable fastening system, the washer has a second thickness 73b (shown in FIG. 10B) equal to the middle portion thickness 73a due to the deformation of the washer. The tapers 62 on the washer 60 are preferably formed using two opposing dies that are specifically shaped to form the tapers. A fixed stroke machine is preferably used to compress the washer material and form the tapers 62 using the dies. The tapers 62 can be formed either during normal production of the washer using specially shaped tooling (with the taper features), or as a secondary operation using similar tooling.

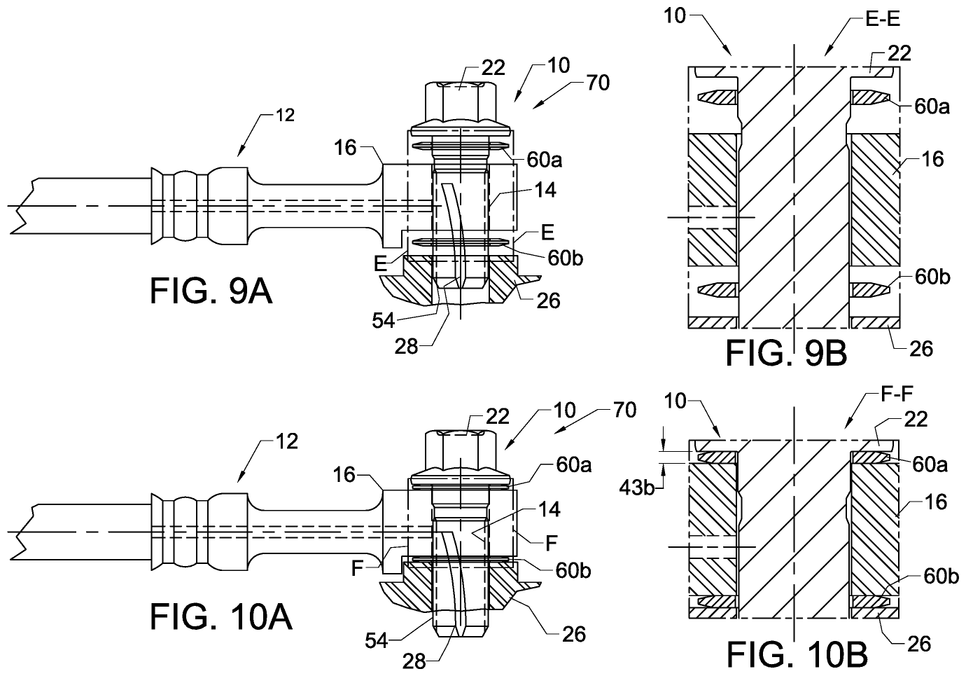

FIGS. 9A, 9B, 10A, and 10B show a fastening system 70 being used to install a flow bolt 10 on a brake hose 12. The fastening system employs the tapered washer 60 shown in FIGS. 7 and 8, described previously. Specifically, FIG. 9A and 9B show the pre-installed state while FIGS. 10A and 10B show the post-installed state. In fact, two of the tapered washers 60 are used. Therefore, in FIGS. 12 and 13, one washer is identified with reference numeral 60a and the other is identified with reference numeral 60b, to distinguish one from the other. Therefore, in FIGS. 9A, 9B, 10A and 10B, one washer is identified with reference numeral 60a and the other is identified with reference numeral 60b to distinguish one from the other, yet both are preferably identical to washer 60 shown in FIGS. 7 and 8.

Initially, a tapered washer 60a (identical to the tapered washer 60 shown in FIGS. 7 and 8) is slid onto the shaft 54 of the flow bolt 10 and then the shaft 54 of the flow bolt 10 is inserted through a bore 14 provided in a connector 16 at the end of the brake hose 12. At this point, the washer 60a is disposed between a head 22 of the flow bolt 10 and the connector 16. Then, another tapered washer 60b (also preferably identical to the tapered washer 60 shown in FIGS. 7 and 8) is slid onto the shaft 54 of the flow bolt 10. Then, a securing member 26, such as a nut member, is threaded or otherwise engaged with the shaft 54 of the flow bolt 10. At this point, the washer 60b is disposed between the connector 16 and the securing member 26, and the overall assembly looks as shown in FIGS. 9A and 9B. Then, the fastener system 70 is tightened such as by rotating the head 22 of the flow bolt 10 and/or securing member 26, or the securing member 26 is crimped onto the shaft 54 of the flow bolt 10. Regardless, tightening of the fastener system 70 causes the tapered washers 60a, 60b to compress or crush against the connector 16, thereby forming a seal as shown in FIGS. 10A and 10B. During installation, the top 64 and bottom 66 of the washer 60 (see FIGS. 10A and 10B) can be crushed such that the thickness of the washer 60 after installation substantially equals the thickness of the middle portion 72 (shown in FIG. 8) of the washer 60 as it existed before installation (see FIGS. 9A and 9B), but this is not imperative.

Providing that that the washers 60a, 60b have at least one taper 62 (see washer 60 shown in FIGS. 7 and 8, which is identical), and was effectively pre-crushed before being used in the flow bolt installation process provides that the clamp force is reduced as a result of the contact area of the washer forming the sealed joint being reduced compared to that of the contact area of a conventional, non-tapered washer. The fact that the washers 60a, 60b have at least one taper 62 on the top 64 and bottom 66 reduces the force required to install the washer to seal with the flow bolt 10 and to the connector assembly 16, for example, a flow bolt 10, while still maintaining the radial strength of the washers 60a, 60b. Preferably, the washer design is matched to compensate for reduced thread strength in that the crush area is reduced approximately by the amount of thread strength reduction. As discussed above, the thread strength may be compromised in that the thread of either the bolt or the nut member may be susceptible to stripping if the flow bolt 10 includes one or more external flutes 28 (shown in FIGS. 9A, 9B, 10A, 10B) across the threads in order to provide a fluid flow path. Using tapered washers 60a, 60b (see FIGS. 7 and 8 which shows washer 60 which is identical) compared to conventional washers provides that less axial force is required to crush and seal the washer to the flow bolt 10 and to both the connector assembly 16 and the securing member 26 due to the smaller crush area.

The stepped and tapered washers as shown in FIGS. 3-4 and 7-8, respectively, can be used to install standard, non-flow bolts as well as flow bolts, and specifically flow bolts having one or more external flutes running across the threads. Regardless, using the non-conventional washers disclosed herein provides for a reduced crush area which results in less clamp force being required for proper installation. Even standard flow bolts which do not have one or more external flutes cut or otherwise formed across the threads would benefit from a reduced clamp load due to the lower cross-sectional area of the bolt

During installation, the increasing axial load causes the deformable fastening member (i.e., the stepped or tapered washers, as described above) to deform until a desired clamp load is reached. The outer portions cause the contact area to be less than the contact area of a conventional non-deformable or non-stepped washer. Even though less material is in contact, the washer material that is loaded deforms more to better seal any voids in the joint. This seals the joint with a lower axial force (torque) than when a standard crush washer is used.

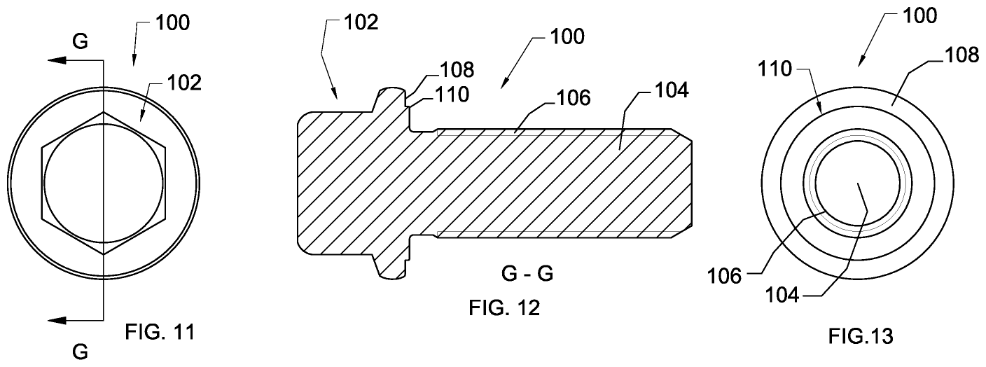

FIGS. 11, 12 and 13 provide a top view, side cross-sectional view, and bottom view, respectively, of a non-deformable fastener defined by a bolt 100 which is in accordance with another embodiment of the present invention. As shown, the bolt 100 includes a head 102 (see FIGS. 11 and 12) and a shaft 104 (see FIGS. 12 and 13) having a thread 106 formed thereon. Both the head 102 and the shaft 104 may be conventional except for the undersurface 108 under the head 100, which is provided as having at least one inner step 110 thereon, wherein the at least one step defines the at least one outer portion of the deformable fastening system

In an embodiment of the invention, the undersurface 108 may have a “torque robbing feature” such as adding texture to the undersurface 108 that provides high friction to the undersurface 108 when contacting a mating surface. The texture may be any geometry that transforms the undersurface 108 into a high friction surface. One such feature preferably may be ribs added to the undersurface 108 that makes the undersurface 108 a high friction surface and allows the required clamp load to be reached faster with less torque applied to seal the deformable fastening system.

As shown in FIG. 13, preferably the at least one step 110 is circular and concentric with the shaft 104 (and the bolt 100 in general).

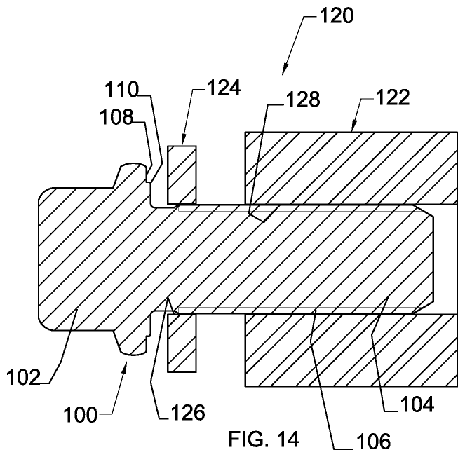

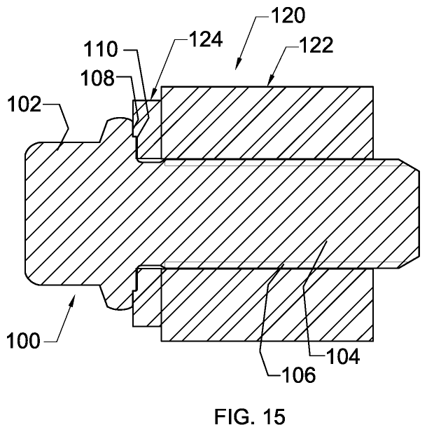

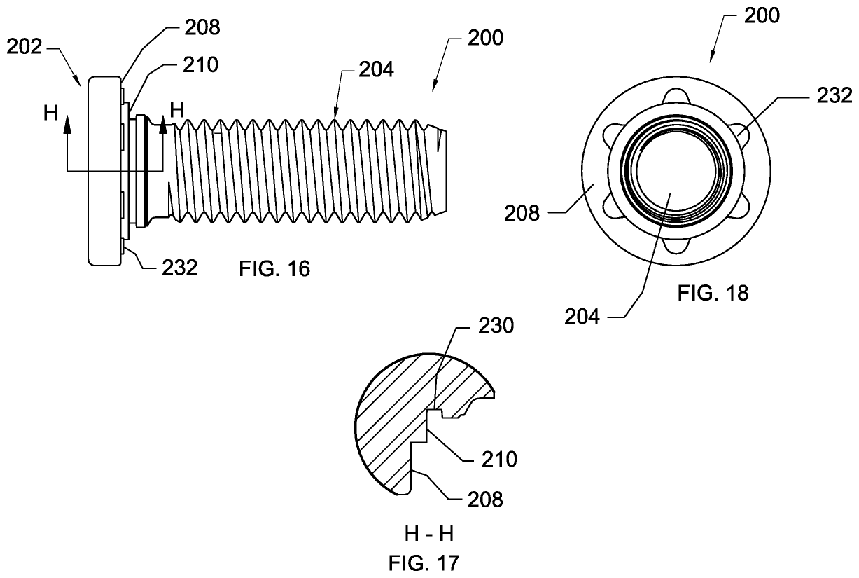

FIGS. 14 and 15 provide cross-sectional views of a fastening system 120 that is in accordance with an embodiment of the present invention. The fastening system 120 employs the bolt 100 shown in FIGS. 11-13, described previously, as well as a nut member 122 and a clamped component 124, such as a washer, which is disposed between the nut member 122 and the undersurface 108 of the head 102 of the bolt 100. Preferably, the clamped component 124 is made of a softer material than both the bolt 100 and the nut member 122. In the embodiment shown in FIGS. 14-15, the bolt 100 is a non-deformable fastener and the clamped component is the deformable member. However, in another embodiment of the present invention, the at least one step 110 may be a softer material than a mating surface and may deform to seal against the mating surface. In this embodiment, the at least one step is the deformable member and the mating surface is the mating member.

While FIG. 14 shows the fastening system 120 before the bolt 100 is installed, FIG. 15 shows the fastening system 120 after the bolt 100 is installed. As shown in FIG. 14, initially the shaft 104 of the bolt 100 is inserted through a hole 126 in the clamped component 124, and the thread 106 on the shaft 104 is engaged with a corresponding thread 128 in the nut member 122, causing the clamped component 124 to be effectively captured between the head 102 of the bolt 100 and the nut member 122. To fully install the bolt 100, the bolt 100 is rotated using the head 102, in order for the bolt 100 to move more fully into the nut member 122 and clamp down on the clamped component 124. Providing one or more outer portions 110 under the head 102 (i.e., on the underside 108 of the head 102) causes a significant increase in torque during the tightening cycle as compared to a conventional head having a flat, non-stepped undersurface, which indicates that a predetermined clamp load has been reached.

During installation, the increasing axial load causes the clamped material (i.e., clamped component 124) to deform until a desired clamp load is reached. The area of the outer portion 110 is calculated so that the required clamp load is reached once the undersurface 108 (i.e., the surface indicated with reference numeral 108 in FIG. 14) in the bolt 100 makes contact with the clamped component 124. Thus, if there is no gap between the undersurface (i.e., the surface indicated with reference numeral 108 in FIG. 14) and the clamped component 124, verification of sufficient clamp load is visual. Additionally, when using torque & angle feedback installation equipment, there will be a sudden rise in torque once the undersurface (i.e., the surface indicated with reference numeral 108 in FIG. 14) engages the clamped component 124. This feedback will enable the installation equipment to ensure that full contact and that the required clamp load has been achieved.

While the bolt 100 has been shown having a head 102 with an external hex profile, the head 102 can be provided as having many other different profiles, such as an internal hex profile or even a multi-lobular profile, either internal or external. Additionally, while the term nut member has been used regarding part number 122, the nut member may not really be a nut member in the traditional sense, but can really be anything to which one wants to install the bolt. Thus, the clamped component may be but may be any member that is clamped or captured between the mating member and another component of the deformable fastening system. Finally, while the clamped component 124 has been mentioned as being possibly a washer, the clamped component 124 can also be really be anything which one wants to clamp in the overall assembly using the bolt 100. In another embodiment of the system, a non-deformable fastener comprises: a clinch fastener that seals with and clinches the deformable member.

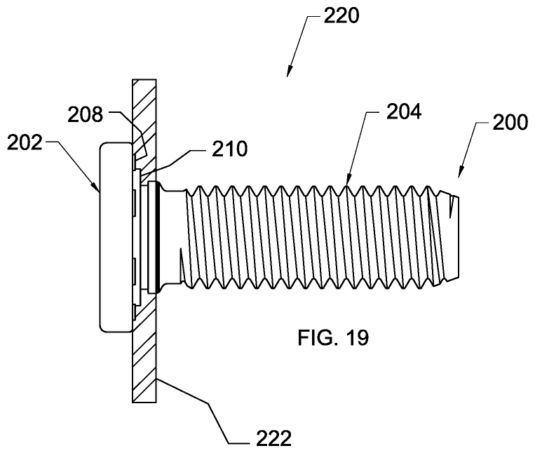

As shown in FIGS. 16-19, the deformable fastening system is in accordance with another embodiment of the present invention, wherein the deformable fastening system 220 (shown in FIG. 19) includes a non-deformable fastener defined by a bolt 200 having a clinch feature. FIG. 16 shows the pre-installed state of the system; FIG. 17 shows a cross sectional view of Section H-H of FIG. 16, FIG. 18 shows a bottom view of FIG. 16, and FIG. 19 shows the post-installed state of the system, wherein the deformable member is a staking material 222.

As shown, the bolt 200, similar to the bolt 100 in FIGS. 11-15, includes a head 202 (see FIGS. 16 and 19) and a shaft 204 (see FIGS. 16, 18, and 19). Both the head 202 and the shaft 204 may be conventional except for the undersurface 208 under the head 200, which is provided as having at least one inner step 210 thereon (shown in detail in FIG. 17), wherein the undersurface 208 and the at least one inner step 210 have similar features to the corresponding undersurface 108 and at least one inner step 210 associated with bolt 100.

As shown in FIG. 18, additional features may be added such as ribs 232 to reduce axial rotation.

Additionally, the bolt 200 has a clinch feature, shown as retaining groove 230 that allows for flow and retention of retained material 222 (shown in FIG. 19) during a staking operation. Preferably, the retained staking material 222 is softer than the bolt material. The at least one step 210 defining at least one outer portion mates with the staking material and acts as sealing feature and may include more than one step to further seal with the staked material 222.

While FIG. 16 shows the fastening system 220 before the bolt 200 is installed, FIG. 19 shows the fastening system 220 after the bolt 200 is installed into staking material 222.

During installation, the increasing axial load causes the staked material 222 to deform and a portion of the staked material flows into the retention groove, thereby clinching the staked material 222 and forming a seal with the staked material 222.

While the embodiment shown in FIG. 16-19 are directed to a clinch bolt, additional embodiments may be directed to an equivalent clinching features of a clinch nut.

With regard to installation of any of the fastening systems disclosed herein (i.e., as shown in FIGS. 5A, 5B, 6A, 6B, 9A, 9B, 10A, 10B and 14-15), a programmable drive system can be utilized, preferably a drive system capable of performing a torque angle tightening strategy. Regardless, the bolt and/or washer configuration disclosed herein provides for a reduced crush area that effectively translates into less axial force being needed to properly install the bolt. Additionally, in several embodiments of the invention as shown in FIGS. 16-19, additional sealing features are provided.

While specific embodiments of the invention have been shown and described, it is envisioned that those skilled in the art may devise various modifications without departing from the spirit and scope of the present invention.

What is claimed is:

1. A deformable fastening system comprising:
a deformable member; and
a mating member that seals with the deformable member, wherein the deformable member requires a reduced clamp load to seal with the mating member than a conventional clamp load required to seal a non-deformable conventional fastener with a conventional mating member in a conventional fastening system.

2. The deformable fastening system of claim 1, wherein the deformable member comprises:
a fastener including at least one step having
an inner portion having a first and a second side opposing the first side, wherein the inner portion is bounded by an inner maximum dimension; and
at least one first outer portion integrally formed with and protruding outwardly from the inner portion first side defining a first outer surface bounded by a first outer maximum dimension less than the inner maximum dimension.

3. The deformable fastening system of claim 2, wherein when a first axial force is applied to the fastener, the first outer surface contacts the mating member at a required axial force to seal the deformable fastening system.

4. The deformable fastening system of claim 3, wherein when the first axial force applied to the fastener to reach the required axial force to seal the deformable fastening system is less than a second axial force applied to the conventional fastener to seal the conventional fastening system.

5. The deformable fastening system of claim 2, wherein the first outer portion comprises:
a rectangular side profile.

6. The deformable fastening system of claim 2, wherein the first outer portion comprises:
a first taper defining a first tapered profile; and
a first planar portion defining the first outer surface.

7. The deformable fastening system of claim 2, wherein the fastener comprises:
a washer having a uniform middle portion defining the inner portion

8. The deformable fastening system of claim 7, wherein the washer comprises:
a first thickness before installation into the deformable fastening system that equals the sum of a middle portion thickness measured longitudinally across the inform middle portion and a step thickness measured longitudinally across the at least one step, wherein, when installed into the deformable fastening system, the washer has a second thickness equal to the middle portion thickness due to the deformation of the washer.

9. The deformable fastening system of claim 7, wherein the washer further comprises:
at least one second outer portion integrally formed with the uniform middle portion that protruding outwardly from the uniform middle portion second side defining a second outer surface bounded by a second outer maximum dimension less than the inner maximum dimension.

10. The deformable fastener of claim 9, wherein the first outer portion comprises:
a first rectangular side profile.

11. The deformable fastening system of claim 10, wherein the at least one second outer portion comprises:
a second rectangular side profile.

12. The deformable fastening system of claim 7, wherein the at least one first outer portion comprises:
a first taper defining a first tapered profile; and
a first planar portion defining the first outer surface.

13. The deformable fastening system of claim 12, wherein the at least one second outer portion comprises:
a second taper defining a second tapered profile; and
a second planar portion defining the second outer surface.

14. The deformable fastening system of claim 1, wherein the mating member comprises:
a non-deformable fastener having at least one outer portion, wherein the non-deformable fastener at least one outer portion contacts the deformable member to deform the deformable member.

15. The deformable fastening system of claim 14, wherein the non-deformable fastener comprises:
a bolt having a shank and a head, the head including an undersurface including at least one step defining the at least one outer portion, wherein the at least one step mates with the deformable member to deform the deformable member and continues to deform the deformable member until the outer portion contacts the deformable member at a desired clamp load.

16. The deformable fastening system of claim 15, wherein the deformable member receives the bolt and comprises:
a washer or a clamped component.

17. The deformable fastening system of claim 14, wherein the non-deformable fastener comprises:
a clinch fastener that seals with and clinches the deformable member.

18. The deformable fastening system of claim 17, wherein the deformable member comprises:
a staking material.

19. The deformable fastening system of claim 18, wherein the clinch fastener comprises:
a bolt having a shank and a head, the head including an underside including at least one step defining the at least one outer portion, wherein the at least one step mates with the staking material to deform. clinch, and seal with the staking material.

20. The deformable fastening system of claim 19, wherein the clinch fastener comprises:
a retention groove, wherein when the bolt is staked through the staking material, a portion of the deformable staking material flows into the retention groove.
